(19) United States
(12) Patent Application Publication
(10) Pub. No.: US 2016/0185658 A1
(43) Pub. Date: Jun. 30, 2016

(54) METHOD FOR MANUFACTURING ANTIFOGGING POROUS SILICA THIN FILM

(71) Applicants: Hyundai Motor Company, Seoul (KR); Korea Advanced Institute of Science and Technology, Daejeon (KR)

(72) Inventors: Sung June PARK, Osan-si (KR); Jin Yong SHIM, Asan-si (KR); Jong Min KIM, Daejeon (KR); Dong Min SIM, Daejeon (KR); Jae Suk CHOI, Daejeon (KR); Yeon Sik JUNG, Daejeon (KR)

(21) Appl. No.: 14/878,914

(22) Filed: Oct. 8, 2015

(30) Foreign Application Priority Data
Dec. 30, 2014 (KR) 10-2014-0194125

(51) Int. Cl. C03C 17/25; C09D 5/16

(52) U.S. Cl. CPC C03C 17/25; C09D 5/1675; C03C 2218/112; C03C 2218/322; C03C 2218/32; C03C 2217/213; C03C 2217/425; C03C 2217/75

(57) ABSTRACT

A method for manufacturing an antifogging porous silica thin film includes preparing a silicon block copolymer micelle solution, forming a coating layer by applying the solution on a substrate using a compressed air spraying method, forming a porous silica thin film by subjecting the coating layer to an oxygen plasma treatment, and solvent-annealing the porous silica thin film.

### CROSS-REFERENCE TO RELATED APPLICATION

This application claims under 35 U.S.C. §119(a) the benefit of priority to Korean Patent Application No. 10-2014-0194125 filed on Dec. 30, 2014, the entire contents of which are incorporated herein by reference.

### TECHNICAL FIELD

The present disclosure relates to a method for manufacturing an antifogging porous silica thin film. More particularly, it relates to a method for manufacturing an antifogging porous silica thin film, in which the thin film prevents fogging by the super-hydrophilic property thereof; is allowed to have a large area; and has a process-cost reduction effect, by manufacturing a uniform porous silica thin film using a silicon block copolymer by applying a compressed air spraying method and a solvent annealing method.

### BACKGROUND

A fogging phenomenon is generated by water droplets that are condensed on a surface when the surface temperature of an object has lower temperature of dew point than the temperature of dew point of surrounding atmosphere. At this time, when the condensed water droplets has high contact angle to the surface, the small round water droplets are formed, and thus, scattering of light is generated by this phenomenon, and thereby, the surface becomes haze.

By such a fogging phenomenon, the clarities of a solar cell, display, glasses, and glass of the car, which generally use a clear glass, are reduced, and as a result, for the optical devices, the properties thereof are not developed, properly, and the losses of the functions thereof are shown. Especially, in the case of a car, fine water droplets are formed on the surface of a glass due to the temperature difference between the interior and exterior car, and thus, obstruct driver's field of vision, thereby hindering safe driving.

Therefore, in order to prevent a fogging phenomenon, a surface treatment technique capable of controlling wettability of the surface is required, and the wettability of the surface can be easily controlled through forming a geometric surface structure. For example, the super-hydrophobic (a water contact angle of 150° or more) and super-hydrophilic (a water contact angle of 10° or less) properties can be obtained by a process of manufacturing fine structures in a surface micro/nanometer scale. Such a technique can be applied for a surface treatment technique for a self-cleaning or bacteria-resistant property. In addition, since the super-hydrophilic surface has a water contact angle of 10° or less, while water droplets are not formed and are quickly spread out on the surface, a thin water film is formed to reduce a light scattering phenomenon. Therefore, an antifogging property has a great effect when it has a super-hydrophilic property rather than a super-hydrophobic property.

Generally, as a method for obtaining the surface having a super-hydrophilic property, there are known a method (photochemical) represented by TiO₂, and a method (textured surfaces) for forming structures on a surface. However, for a photochemical method such as TiO₂, the super-hydrophilic property is exhibited only if being exposed to UV, and thus, when being presented in a darkroom for a long period of time, the property is lost. For this reason, a method for forming structures on a surface is drawing attention in order to implement the effect of super-hydrophilic property, consistently. When the fine structures are formed on the surface, the wettability of a surface has been researched by Wenzel, Cassie-Baster, and it can be expected how the wettability changes depending on the roughness of a surface.

According to a Wenzel model, the contact angle of a surface changes depending on the roughness thereof, and follows the following Equation, cos [θ*]=r cos θ (θ*: apparent contact angle, r roughness ratio, θ: Young's contact angle). The r value is an important factor, and is represented by the ratio of a real contact area and projection area. Generally, in the case of a silica film exhibiting the hydrophilic property in the level of a water contact angle of about 25°, when the film has the roughness of a surface, the r value is higher than 1, and as a result, the surface property changes in the direction of improving the hydrophilic property. Generally, the roughness of a surface can be easily imparted by coating a porous film having pores on a substrate, and it is important to control the pores of the coating film for controlling the roughness of the surface.

For providing such a porous coating film, there are a vacuum deposition method, such as, PVD having strong binding power to a glass substrate, CVD, and an oblique-angle deposition method, and a method through a post treatment, such as, a solution etching, UV, heat, acids, and salts, using micelle coating, sol-gel, polyelectrolyte, multi-structure, polymer blending, and a block copolymer. Among them, in the cases of the methods using a polymer blending and a block copolymer, the porous film can be easily and quickly prepared by easily removing the polymer on the one side through etching after coating. However, these methods are difficulty applied for an industry field that requires a uniform large-scale coating in practice due to the limits, such as, low degree of uniformity and small coating area for a coating thickness.

Recently, a technique for easily and quickly manufacturing a silica porous super-hydrophilic surface by coating a silicon-containing block copolymer-polymer thin film through a simple solution process, and by easily removing a polymer on the one side through etching is disclosed in Advanced Optical Materials (Dong-Min SIM and 6 others, 2013, Vol. 1, Page 428 to 433), as a prior art document. However, there are disadvantages in that by a spin coating process, the degree of uniformity for a coating is low and the fabrication of a large area thereof is unfavorable.

In addition, conventionally, Korean Patent No. 1392335 discloses a method for manufacturing a super-hydrophilic coating layer, in which the method includes forming a ceramic coating layer by spraying a ceramic precursor solution with an electric spraying method. However, for the method, there are disadvantages in that a manufacturing process is complicated, and the expense is very heavy.

Therefore, the research on a large area porous coating film capable of preventing fogging at a low cost is required.

The above information disclosed in this Background section is only for enhancement of understanding of the background of the disclosure and therefore it may include information that does not form the prior art that is already known in this country to a person of ordinary skill in the art.

### SUMMARY

The present disclosure has been made in an effort to solve the above-described problems associated with prior art. The present inventors found that the surface of a substrate of embodiments of the present disclosure has a super-hydrophilic property, thereby preventing fogging, and also, it is possible to have a large area, by manufacturing a porous silica thin film using a silicon block copolymer by applying a compressed air spraying method and a solvent annealing method.

In one aspect, the present disclosure provides a method for manufacturing a porous silica thin film capable of preventing fogging by the super-hydrophilic property thereof.

In another aspect, the present disclosure provides a method for manufacturing an antifogging porous silica thin film capable of being made to have a large area.

A method for manufacturing an antifogging porous silica thin film includes: preparing a silicon block copolymer micelle solution; forming a coating layer by applying the solution on a substrate using a compressed air spraying method; forming a porous silica thin film by subjecting the coating layer to an oxygen plasma treatment; and solvent-annealing the porous silica thin film.

In certain embodiments, in the step of preparing a silicon block copolymer micelle solution, the silicon block copolymer micelle may be selected from the group consisting of polystyrene-b-polydimethylsiloxane, polyacrylonitrile-b-polydimethylsiloxane, poly(4-vinylpyridine)-b-polydimethylsiloxane, polyethyleneoxide-b-polydimethylsiloxane, poly(2-vinylpyridine)-b-polydimethylsiloxane, polymethylmethacrylate-b-polydimethylsiloxane, polybutadiene-b-polydimethylsiloxane, polyisobutylene-b-polydimethylsiloxane, polydimethylsiloxane-b-polybutylacrylate, polydimethylsiloxane-b-polyacrylic acid, and mixtures thereof.

In certain embodiments, at least one of a core part and a shell part of the silicon block copolymer micelle may be composed of an inorganic polymer including silicon.

In certain embodiments, the silicon block copolymer micelle may include 1 to 20% by weight of silicon.

In certain embodiments, in the silicon block copolymer micelle solution, an average particle size of micelle may be 10 nm to 20 nm.

In certain embodiments, the substrate may be a glass or transparent plastic.

In certain embodiments, in the step of solvent-annealing, an annealing solvent may be selected from the group consisting of toluene, heptane, tetrahydrofuran (THF), and mixtures thereof.

In certain embodiments, in the step of solvent-annealing, an annealing time may be 20 minutes to 2 hours.

In certain embodiments, a thickness of the porous silica thin film may be 10 to 200 nm. In certain embodiments, an average pore size of the porous silica thin film may be 10 to 200 nm.

In certain embodiments, porosity of the porous silica thin film may be 30 to 90%.

In certain embodiments, the porous silica thin film may be a super-hydrophilic thin film having a contact angle of 0 to 10°.

In certain embodiments, the step of preparing the silicon block copolymer micelle solution may include mixing a silicon block copolymer with an organic solvent to form a mixture and heating the mixture at a temperature of 60° C. for 1 hour.

In certain embodiments, the substrate may be treated with UV or ozone so as to have a hydrophilic property.

Other aspects and embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (for example, fuels derived from resources other than petroleum). As referred to herein, a hybrid vehicle is a vehicle that has two or more sources of power, for example both gasoline-powered and electric-powered vehicles.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIGS. 1A and 1B are a surface contact angle (FIG. 1A) and SEM photographs (FIG. 1B) of the porous silica thin film manufactured in Comparative Example 1;

FIGS. 2A and 2B are a surface contact angle (FIG. 2A) and SEM photographs (FIG. 2B) of the porous silica thin film manufactured in Comparative Example 2;

FIGS. 3A and 3B are SEM photographs illustrating the coverage (FIG. 3A) of the porous silica thin film manufactured in Example 1 according to an embodiment of the present disclosure and the coverage (FIG. 3B) of the porous silica thin film manufactured in Example 2 according to an embodiment of the present disclosure;

FIG. 4 is a SEM photograph of the porous silica thin film manufactured in Example 2 according to an embodiment of the present disclosure; and

FIGS. 5A and 5B are the photographs illustrating a comparison between the fogging phenomenon of a glass beaker (FIG. 5A) that is coated with the porous silica thin film manufactured in Example 2 according to an embodiment the present disclosure and the fogging phenomenon of a glass beaker (FIG. 5B) that is not coated with the porous silica thin film.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

Hereinafter, embodiments of the present disclosure will be described in more detail with reference to one Example.

The method for manufacturing an antifogging porous silica thin film of an embodiment of the present disclosure includes preparing a silicon block copolymer micelle solution; forming a coating layer by spraying the solution on a substrate using a compressed air spraying method; forming a porous silica thin film by subjecting the coating layer to an oxygen plasma treatment; and subjecting the porous silica thin film to a solvent annealing.

For the antifogging porous silica thin film, fogging may be prevented, and it is possible to make the film to have a large area, by manufacturing a uniform porous silica thin film using the silicon block copolymer through applying a compressed air spraying method and a solvent annealing method, thereby exhibiting a low surface contact angle that shows a super-hydrophilic property. Therefore, it may be applied for the large area glass of a car that requires high durability.

The silicon block copolymer micelle in the silicon block copolymer micelle solution may be one or more kinds selected from the group consisting of polystyrene-b-polydimethylsiloxane, polyacrylonitrile-b-polydimethylsiloxane, poly(4-vinylpyridine)-b-polydimethylsiloxane, polyethyleneoxide-b-polydimethylsiloxane, poly(2-vinylpyridine)-b-polydimethylsiloxane, polymethylmethacrylate-b-polydimethylsiloxane, polybutadiene-b-polydimethylsiloxane, polyisobutylene-b-polydimethylsiloxane, polydimethylsiloxane-b-polybutylacrylate, and polydimethylsiloxane-b-polyacrylic acid.

At least one part of a core part and a shell part of the silicon block copolymer micelle may be composed of an inorganic polymer including silicon. In certain embodiments, one part may be composed of an organic polymer. In certain embodiments, the core part of the silicon block copolymer micelle may be composed of an organic polymer and the shell part that surrounds the core part may be composed of an inorganic polymer including silicon. In certain embodiments, the silicon block copolymer may be formed in a type of a block copolymer by binding the organic polymer and the inorganic polymer including silicon by a covalent bond, and thus, may be formed in a type of the micelle having a core-shell structure in order to minimize the surface energy and solubility difference between the two blocks. In addition, in certain embodiments, the core part may be easily removed by an oxidation method using oxygen plasma and a heat treatment, and the shell part that surrounds the core part may be converted into silica. In certain embodiments, the silicon block copolymer micelle may include 1 to 20% by weight of the silicon. In certain embodiments, when the content of silicon is less than 1% by weight in the solution, it may be difficult or even impossible to form a silica dot after an oxidation process, and when it is higher than 20% by weight, it may be difficult or even impossible to dissolve it in the solvent for forming micelle with a block copolymer.

In certain embodiments, in the step of preparing the silicon block copolymer micelle solution, the solution of the micelle structure may be prepared by mixing the silicon block copolymer with an organic solvent and heating the mixture thus obtained at the temperature of 60° C. for 1 hour. At this time, in certain embodiments, as the organic solvent, a solvent that can dissolve the organic polymer block without silicon may be used. For example, as the solvent, toluene may be used, but the present disclosure is not limited thereto.

In certain embodiments, the size of the micelle in the silicon block copolymer micelle solution may be 10 nm to 20 nm. When the size of the micelle is smaller than 10 nm, it is difficult to structuralize it into a superfine dot, and when it is larger than 20 nm, the durability of a thin film may be reduced after an oxidation process.

In certain embodiments, in the step of forming a coating layer on a substrate using the solution through a compressed air spraying method, the substrate may be a glass or transparent plastic. In certain embodiments, the glass or transparent plastic substrate may be treated with UV or ozone so as to have a hydrophilic property, and then, may be used.

For the compressed air spraying method, as compared with other electro-spraying method and ultrasonic spraying methods, since a process equipment is simple, a process time is short, and various types of raw solutions may be sprayed, thereby lowering the barrier to entry, the compressed air spraying method may be easily applied for various devices. In certain embodiments, in the compressed air spraying method, the solution may be sprayed in a vertical spraying method through the movements of X and Y axis at regular intervals under the conditions of room temperature, a pressure of 3 bar, and 11 μl/min or 22 μl/min to form a coating layer in a state of a liquid drop.

In certain embodiments, in the step of forming a porous silica thin film by treating the coating layer with oxygen plasma, the oxygen (O₂) plasma may be performed with an etching process and an oxidation process, in which the block polymer on one side of the coating layer may be etched and removed through the etching process, and also, after forming pores, the block polymer including silicon (Si) may be oxidized through the oxidation process to form a high density porous silica (SiO₂) thin film.

In certain embodiments, in the step of solvent-annealing the porous silica thin film, the annealing solvent may be one or more kinds selected from the group consisting of toluene, heptane, and tetrahydrofuran (THF). In certain embodiments, as the annealing solvent, the same solvents as the organic solvents that mix a silicon block copolymer may be used, and when using the same solvents, the fluidity of the thin film may be further improved.

In addition, the solvent annealing is the field that is actively researched for the patterning process of a block copolymer. The solvent is a strong external field that can impart directivity to the orientation of a block copolymer domain when being volatilized, and thus, during annealing, the solvent may allow the polymer chain to have sufficient movement, thereby removing a structure bond in the block copolymer, and may form the structure having a complete arrangement over the wide region. In certain embodiments, the solvent may impart fluidity to the coating layer so as to anneal the coated porous silica thin film, thereby forming a large area thin film having high degree of uniformity. At this time, as the annealing time, the annealing may be performed for 20 minutes to 2 hours. When the annealing time is shorter than 20 minutes, the fluidity may be insufficient, and thus, it is difficult to obtain a uniform large area film. When it is longer than 2 hours, the coverage of the film may be reduced by dewetting. In certain embodiments, the annealing may be performed for 30 minutes to 1 hour.

In certain embodiments, the thickness of the porous silica thin film may be 10 to 200 nm. In detail, when the thickness of the thin film is thinner than 10 nm, it is difficult to form a uniform thin film after an oxidation process. When it is thicker than 200 nm, the time for an oxidation process may be increased, and the structure during the oxidation process may be collapsed, thereby reducing pores.

In certain embodiments, the average pore size of the porous silica thin film may be 10 to 200 nm. In detail, when the pore size of the thin film is smaller than 10 nm, it may be difficult to implement a super-hydrophilic property, and when it is larger than 200 nm, the surface may become hazy due to the scattering of light. In certain embodiments, the pore size is smaller than the visible ray area, and thus, the scattering phenomenon of light may be prevented.

According to certain embodiments the present disclosure, the porosity of the porous silica thin film may be 30 to 90%. In detail, when the porosity is lower than 30%, the adhesive strength to a substrate after oxidation may be weak, and when it is higher than 90%, the water contact angle that is similar to a glass substrate is exhibited, and thus, it may be difficult to implement a super-hydrophilic property.

In certain embodiments, the porous silica thin film may be prepared with a super-hydrophilic thin film having a contact angle to water of 0 to 10°. In certain embodiments, the contact angle may form the surface of the silica having a contact angle of 25° to have a porous structure, and may control the pore size, thereby forming a super-hydrophilic thin film. The porous silica thin film may have a super-hydrophilic property, thereby preventing fogging generated on the surface of a substrate.

Therefore, according to the method for manufacturing an antifogging porous silica thin film according to embodiments of the present disclosure, a uniform porous silica thin film may be formed by using a silicon block copolymer through applying a compressed air spraying method and a solvent annealing method, thereby making the surface of a substrate to be super-hydrophilic, and thus, preventing fogging. In addition, it is easy to make the thin film to have a large area and a process-cost reduction effect is exhibited by imparting fluidity to the thin film through a solvent annealing.

### EXAMPLES

The following examples illustrate the disclosure and are not intended to limit the same.

### Example 1

Polystyrene-b-polydimethylsiloxane (PS-PDMS) (55 kg/mol, 0.3% by weight) diluted with toluene was heat-treated at 60° C. for 1 hour to prepare 200 μl of the polystyrene-b-polydimethylsiloxane micelle solution. Then, the solution thus obtained was sprayed on a glass substrate having the size of 10 cm×10 cm in a compressed air spraying way under the condition of room temperature, a pressure of 3 bar, and 22 μl/min to prepare a coating layer in a state of a liquid drop. Then, the coating layer was oxidized under the condition of 30 sccm and 15 mtorr using an oxygen (O₂) plasma method to form a porous silica thin film having a thickness of 100 nm. Then, the porous silica thin film was attached upside down at the cover of a container including 35 ml of toluene, and thus, toluene steam was exposed thereto for annealing the film for 30 minutes, thereby forming the large area porous silica thin film having high degree of uniformity.

### Example 2

Example 2 was performed in the same method as Example 1, except that the porous silica thin film was attached upside down at the cover of a container including 35 ml of toluene, and thus, toluene steam was exposed thereto for annealing the film for 60 minutes, thereby forming the large area porous silica thin film having high degree of uniformity.

### Comparative Example 1

Polystyrene-b-polydimethylsiloxane (PS-PDMS) (55 kg/mol, 0.3% by weight) diluted with toluene was heat-treated at 60° C. for 1 hour to prepare 110 μl of the polystyrene-b-polydimethylsiloxane micelle solution. Then, the solution thus obtained was sprayed on a glass substrate having the size of 10 cm×10 cm in a compressed air spraying way under the condition of room temperature, a pressure of 3 bar, and 11 μl/min to prepare a coating layer in a state of a liquid drop. Then, the coating layer was oxidized under the condition of 30 sccm and 15 mtorr using an oxygen (O₂) plasma method to form a porous silica thin film.

### Comparative Example 2

Polystyrene-b-polydimethylsiloxane (PS-PDMS) (55 kg/mol, 0.3% by weight) diluted with toluene was heat-treated at 60° C. for 1 hour to prepare 220 μl of the polystyrene-b-polydimethylsiloxane micelle solution. Then, the solution thus obtained was sprayed on a glass substrate having the size of 10 cm×10 cm in a compressed air spraying way under the condition of room temperature, a pressure of 3 bar, and 22 μl/min to prepare a coating layer in a state of a liquid drop. Then, the coating layer was oxidized under the condition of 30 sccm and 15 mtorr using an oxygen (O₂) plasma method to form a porous silica thin film.

Experiment Results

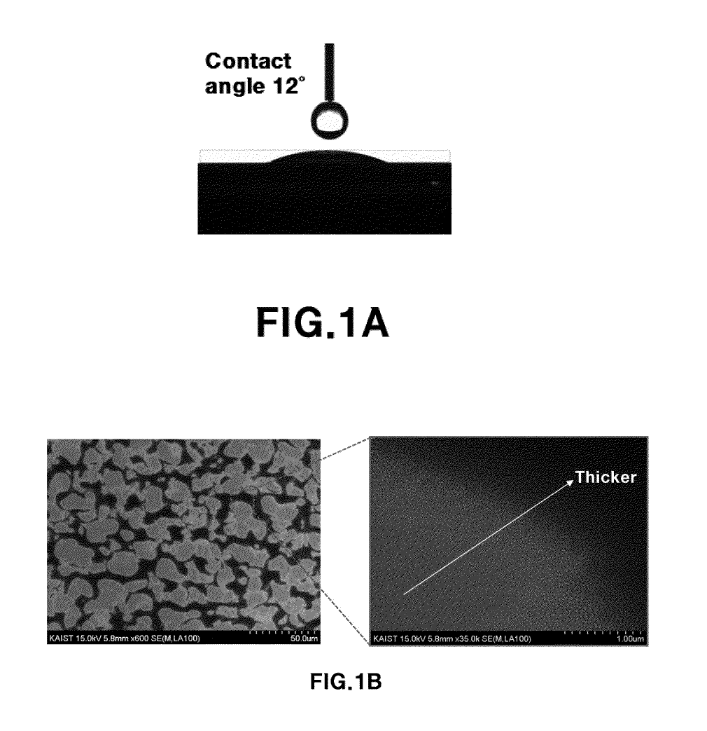

In order to confirm the optical properties of the porous silica thin films manufactured in Examples 1 and 2 and Comparative Examples 1 and 2, the contact angles were measured with a contact angle analyzer, and then, the surfaces of the thin films were confirmed with a scanning electron microscope (SEM). The results thus obtained are illustrated in FIGS. 1A to 4.

FIGS. 1A and 1B are a surface contact angle (FIG. 1A) and SEM photographs (FIG. 1B) of the porous silica thin film manufactured in Comparative Example 1. The FIG. 1A shows a surface contact angle of 12°, and thus, it can be confirmed that it does not satisfy a super-hydrophilic property (10° or less). In addition, from the FIG. 1B, it can be observed that the intensity difference between a light part (the part without the thin film formed) and a dark part (the part with a thin film formed) is clear, and thus, it can be confirmed that the thin film is not uniformly formed on the large area. In addition, as a result of confirming a portion of the thin film at high magnifications, as the thickness of the thin film is thick, the porous surface can be observed, and the coverage ratio of the porous silica thin film to the whole area of the substrate is 35%.

As described above, as a result of measuring the contact angle of FIGS. 1A and 1B, it can be confirmed that the surface of the thin film shows wettability that is close to the super-hydrophilic property, but the coverage of the thin film is not high. Therefore, the thin film does not satisfy the super-hydrophilic property (10° C. or less) for preventing fogging, and the haze is generated on the thin film, and thus, the optical properties are not satisfied.

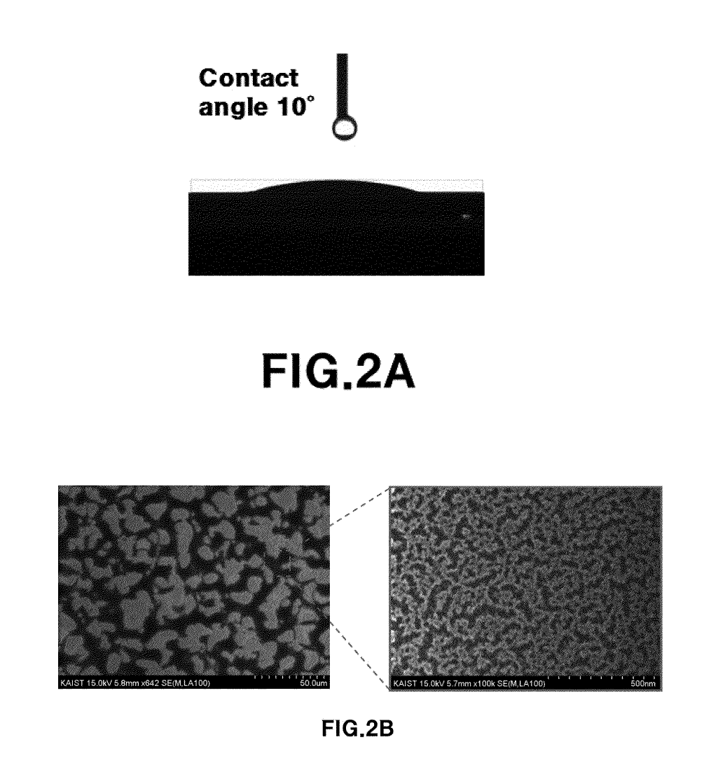

FIGS. 2A and 2B are a surface contact angle (FIG. 2A) and SEM photographs (FIG. 2B) of the porous silica thin film manufactured in Comparative Example 2. The FIG. 2A shows a surface contact angle of 10°, and thus, it can be confirmed that it satisfy a super-hydrophilic property (10° or less). However, from the FIG. 2B, it can be observed that the intensity difference between a light part (the part without the thin film formed) and a dark part (the part with a thin film formed) is clear. In addition, as a result of confirming a portion of the thin film at high magnifications, it can be confirmed that the porous surface is observed on the dark part. The coverage ratio of the thin film to the whole area of the substrate is 50%. It can be confirmed that as compared with FIGS. 1A and 1B, the coverage ratio is increased using two times polymer solution.

As described above, as a result of measuring the contact angle of FIGS. 2A and 2B, it can be confirmed that the surface of the thin film shows wettability (the contact angle of 10°) that is close to the super-hydrophilic property, but the coverage of the thin film is not high. Therefore, the thin film does not satisfy the optical properties, such as, haze, to be required.

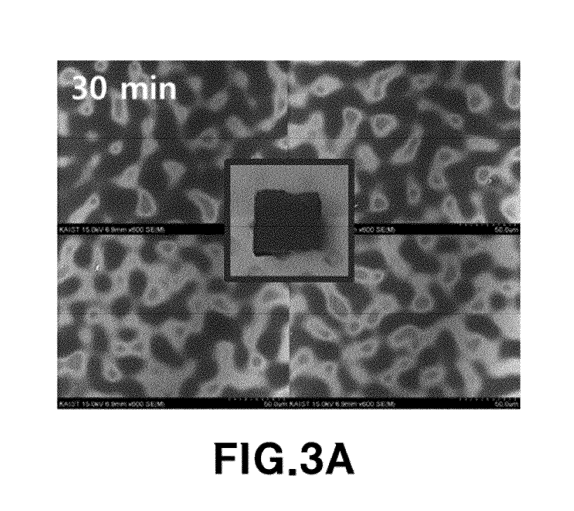

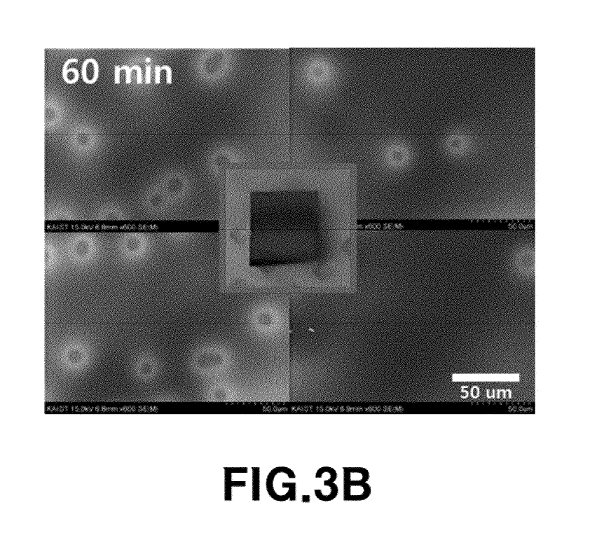

FIGS. 3A and 3B are SEM photographs illustrating the coverage (FIG. 3A) of the porous silica thin film manufactured in Example 1 and the coverage (FIG. 3B) of the porous silica thin film manufactured in Example 2. As can be confirmed in FIG. 3, the FIG. 3A shows 67% of the coverage ratio of the thin film to the whole area of the substrate, and the FIG. 3B shows 90% of the coverage ratio of the thin film to the whole area of the substrate. In addition, the haze shown after forming the thin film is reduced, respectively. As described above, it can be confirmed that for the porous silica thin films manufactured in Examples 1 and 2, the dark part is increased as time passed, and thus, the coverage of the thin films is improved.

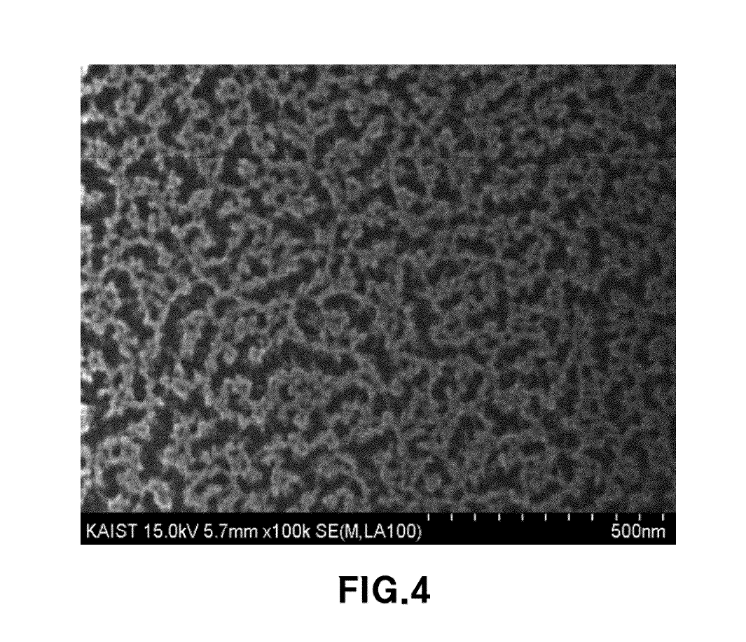

FIG. 4 is a SEM photograph of the porous silica thin film manufactured in Example 2. As can be confirmed in FIG. 4, the light part and dark part are uniformly formed, and especially, the porous surface in the dark part is observed.

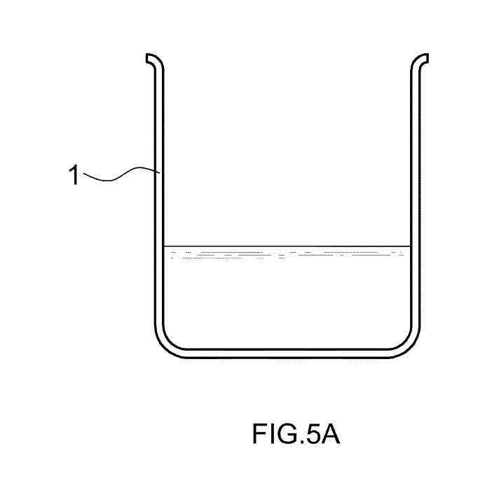

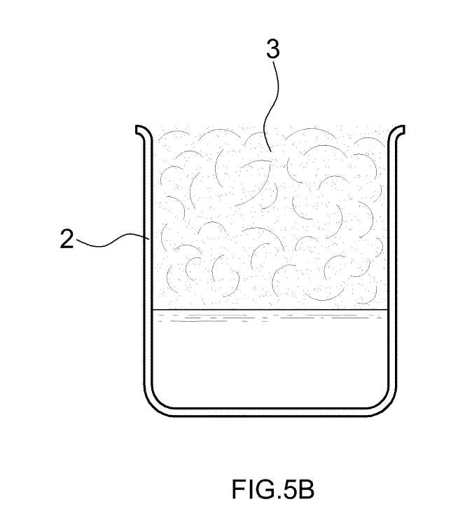

FIGS. 5A and 5B are the photographs illustrating the comparison between the fogging phenomenon of a glass beaker (FIG. 5A) that is coated with the porous silica thin film manufactured in Example 2 and the fogging phenomenon of a glass beaker (FIG. 5B) that is not coated with the porous silica thin film. As can be confirmed that when being exposed under the condition of high temperature and humidity (90° water vapor) for 1 second to 5 seconds, for the FIG. 5B, fine water droplets are not spread on the surface of the glass beaker (2), and thus, are formed, thereby forming haze (3) along with the scattering of light. On the contrary, for the FIG. 5B, the water droplets are not formed on the surface of the glass due to the super-hydrophilic thin film on the surface of the glass beaker (1) coated with the porous silica thin film, and thus, the water droplets are collected in the bottom of the glass, so as not to generate the haze and affect the optical properties.

Therefore, as for the porous silica thin films manufactured in Examples 1 and 2, the surface of a substrate can be made to have a super-hydrophilic property, thereby preventing fogging by manufacturing a uniform porous silica thin film using a silicon block copolymer by applying a compressed air spraying method and a solvent annealing method. In addition, it can be confirmed that fluidity can be imparted on the thin film by subjecting the thin film to a solvent annealing, and thus, it is easy to make the thin film to have a large area.

As set forth above, according to the method for manufacturing an antifogging porous silica thin film according to embodiments of the present disclosure, the surface of a substrate can be made to have a super-hydrophilic property, thereby preventing fogging by manufacturing a uniform porous silica thin film using a silicon block copolymer by applying a compressed air spraying method and a solvent annealing method. In addition, fluidity can be imparted on the thin film by subjecting the thin film to a solvent annealing, and thus, it is easy to make the thin film to have a large area, and a process-cost reduction effect can be shown.

The disclosure has been described with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method for manufacturing an antifogging porous silica thin film, the method comprising:
preparing a silicon block copolymer micelle solution;
forming a coating layer by applying the solution on a substrate using a compressed air spraying method;
forming a porous silica thin film by subjecting the coating layer to an oxygen plasma treatment; and
solvent-annealing the porous silica thin film.

2. The method of claim 1, wherein in the step of preparing a silicon block copolymer micelle solution, the silicon block copolymer micelle is selected from the group consisting of polystyrene-b-polydimethylsiloxane, polyacrylonitrile-b-polydimethylsiloxane, poly(4-vinylpyridine)-b-polydimethylsiloxane, polyethyleneoxide-b-polydimethylsiloxane, poly(2-vinylpyridine)-b-polydimethylsiloxane, polymethylmethacrylate-b-polydimethylsiloxane, polybutadiene-b-polydimethylsiloxane, polyisobutylene-b-polydimethylsiloxane, polydimethylsiloxane-b-polybutylacrylate, polydimethylsiloxane-b-polyacrylic acid, and mixtures thereof.

3. The method of claim 2, wherein at least one of a core part and a shell part of the silicon block copolymer micelle is composed of an inorganic polymer including silicon.

4. The method of claim 2, wherein the silicon block copolymer micelle includes 1 to 20% by weight of silicon.

5. The method of claim 1, wherein in the silicon block copolymer micelle solution, an average particle size of micelle is 10 nm to 20 nm.

6. The method of claim 1, wherein the substrate is a glass or transparent plastic.

7. The method of claim 1, wherein in the step of solvent-annealing, an annealing solvent is selected from the group consisting of toluene, heptane, tetrahydrofuran (THF), and mixtures thereof.

8. The method of claim 1, wherein in the step of solvent-annealing, an annealing time is 20 minutes to 2 hours.

9. The method of claim 1, wherein a thickness of the porous silica thin film is 10 to 200 nm.

10. The method of claim 1, wherein an average pore size of the porous silica thin film is 10 to 200 nm.

11. The method of claim 1, wherein porosity of the porous silica thin film is 30 to 90%.

12. The method of claim 1, wherein the porous silica thin film is a super-hydrophilic thin film having a contact angle of 0 to 10°.

13. The method of claim 1, wherein the step of preparing the silicon block copolymer micelle solution comprises mixing a silicon block copolymer with an organic solvent to form a mixture and heating the mixture at a temperature of 60° C. for 1 hour.

14. The method of claim 6, wherein the substrate is treated with UV or ozone so as to have a hydrophilic property.
